(19) United States
(12) Patent Application Publication
(10) Pub. No.: US 2011/0029403 A1
(43) Pub. Date: Feb. 3, 2011

(54) SYSTEM AND METHOD FOR TARGETED MERCHANDISING TO RETURNING USERS

(75) Inventor: Xiaochun Xu, Shanghai (CN)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 12/511,473

(22) Filed: Jul. 29, 2009

(51) Int. Cl. G06Q 30/00

(52) U.S. Cl. 705/26.7; 705/14.53; 705/27.1

(57) ABSTRACT

In various exemplary embodiments, a system and associated method to provide targeted merchandising is disclosed. Initially, an identity of a user (e.g., a returning buyer) is determined. A transaction history associated with the identity is then accessed. The transaction history is used to determine one or more related items from at least one familiar merchant. The at least one familiar merchant is a merchant having a previous relationship with the user. Representations of the one or more related items are then displayed to the user in a prominent manner.

### TECHNICAL FIELD

The present application relates generally to the field of computer technology and, in a specific exemplary embodiment, to a system and method for targeted merchandising to returning users of a network-based marketplace.

### BACKGROUND

In a multi-seller network-based marketplace, a plurality of merchants or sellers can each list one or more items for sale. Buyers can then offer to purchase one or more of the items. When purchasing within the network-based marketplace, trust between buyers and sellers is important. Typically, a buyer is more inclined to purchase from a seller with whom they have had a previous, positive transaction.

### BRIEF DESCRIPTION OF DRAWINGS

Various ones of the appended drawings merely illustrate exemplary embodiments of the present invention and cannot be considered as limiting its scope.

FIG. 1 is a block diagram illustrating an exemplary embodiment of a high-level, client-server-based network architecture of a system used to provide targeted merchandising.

FIG. 2 is a block diagram illustrating an exemplary embodiment of a marketplace system of the network architecture of FIG. 1.

FIG. 3 is a block diagram illustrating an exemplary merchandising engine.

FIG. 4 is a flowchart illustrating an exemplary method for providing targeted merchandising in a search result.

FIG. 5 is a flowchart illustrating an exemplary method for providing targeted merchandising in a virtual store.

FIG. 6 is a flowchart illustrating an exemplary method for providing targeted merchandising on a requested web page.

FIG. 7 is a simplified block diagram of a machine in an exemplary form of a computing system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody the present inventive subject matter. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on a network-based marketplace environment, the embodiments are given merely for clarity in disclosure. Thus, any type of electronic commerce or electronic business system and method, including various system architectures, may employ various embodiments of the targeted merchandising system and method described herein and are considered as being within a scope of exemplary embodiments. Each of a variety of exemplary embodiments is discussed in detail, below.

Exemplary embodiments provide a system and method for providing targeted merchandising to returning users. Since users are more inclined to purchase from, or transact with, merchants or sellers with whom the user has a previous relationship such as, for example, a positive transaction or is otherwise known to the user (collectively referred to herein as a “familiar merchant”), providing targeted merchandising from these familiar merchants is beneficial to both the user and the merchants. The targeted merchandising may include items from the familiar merchant as well as items that are related to an item that was previously purchased from a familiar merchant. For example, accessories for the previously purchased item or an upgraded version of the previously purchased item may be emphasized (e.g., displayed more prominently) to the returning user.

In various exemplary embodiments, a system and associated method to provide targeted merchandising is disclosed. Initially, an identity of a user (e.g., a returning buyer) is determined. A transaction history associated with the identity is then accessed. The transaction history is used to determine one or more related items from at least one familiar merchant. The at least one familiar merchant is a merchant having a previous relationship with the user. Representations of the one or more related items are then displayed to the user in a prominent manner.

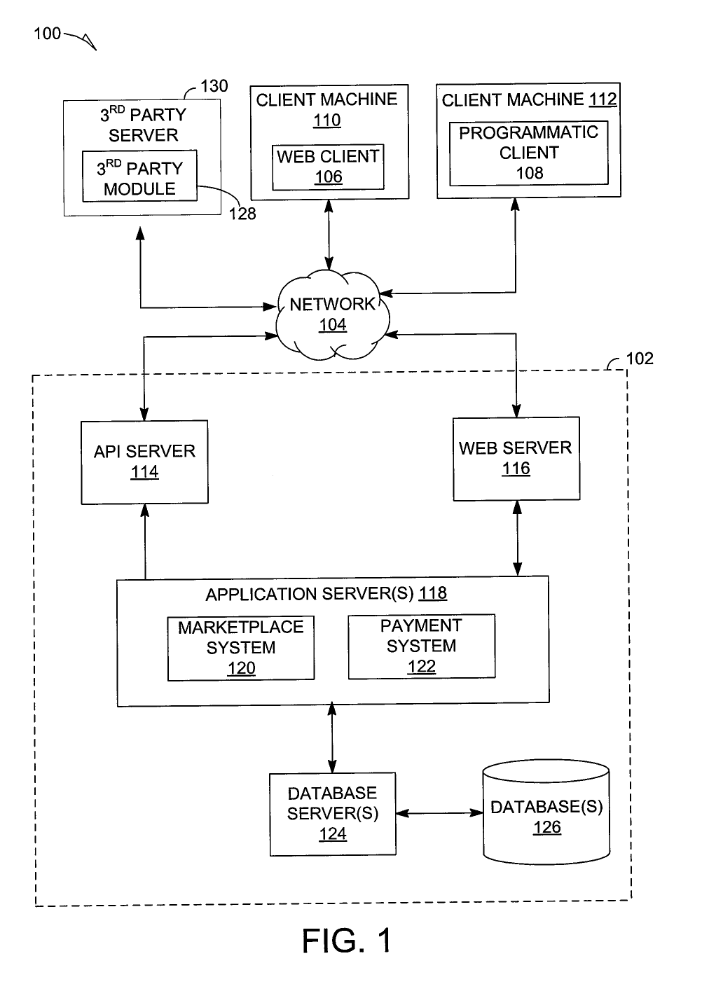

With reference to FIG. 1, an exemplary embodiment of a high-level client-server-based network architecture 100 for providing targeted merchandising to a returning user is shown. A networked system 102, in an exemplary form of a network-server-side functionality, is coupled via a network 104 (e.g., the Internet or Wide Area Network (WAN)) to one or more clients. FIG. 1 illustrates, for example, a web client 106 operating via a browser (e.g., such as the Internet Explorer® browser developed by Microsoft® Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host a marketplace system 120 and a payment system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage database(s) 126.

The information storage databases 126 may include a plurality of tables (not shown). A user table contains a record for each registered user of the network-based marketplace, and may include identifier, address, and financial instrument information pertaining to each such registered user. A user may, it will be appreciated, operate as a seller, a buyer, or both, within the network-based marketplace. The tables also include an items table that maintains item records (e.g., item information) for goods and services that are available to be, or have been, transacted via the network-based marketplace. Each item record within the items table may furthermore be linked to one or more user records within the user table, so as to associate a seller and one or more actual or potential buyers with each item record. A transaction table contains a record for each transaction (e.g., a purchase transaction) pertaining to items for which records exist within the items table. A history table maintains a history of transactions to which a user has been a party. One or more attributes tables record attribute or metadata information pertaining to items for which records exist within the items table.

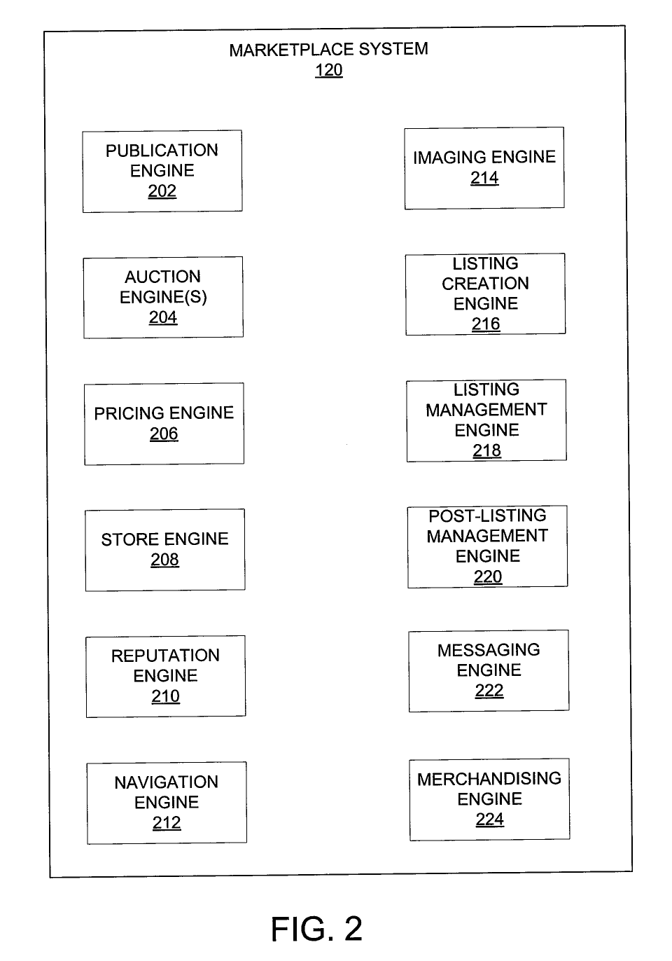

The marketplace system 120 provides a number of marketplace functions and services to users that access the networked system 102. The marketplace system 120 is discussed in more detail in connection with FIG. 2.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the marketplace system 120. The payment system 122 also facilitates payments from a payment mechanism (e.g., a bank account or credit card) for purchases of items via the network-based marketplace. While the marketplace system 120 and the payment system 122 are shown in FIG. 1 to both form part of the networked system 102, it will be appreciated that, in alternative embodiments, the payment system 122 may form part of a payment service that is separate and distinct from the networked system 102.

FIG. 1 also illustrates a third party module 128, executing on a third party server 130, as having programmatic access through the network 104 to the networked system 102 via the programmatic interface provided by the API server 114. For example, the third party module 128 may, utilizing information retrieved from the networked system 102, support one or more features or functions on a website (not shown) hosted by the third party. The third party website may, for example, provide one or more promotional, marketplace, or payment functions that are supported by the relevant applications of the networked system 102.

While the exemplary network architecture 100 of FIG. 1 employs a client-server architecture, a skilled artisan will recognize that the present disclosure is not limited to such an architecture. The exemplary network architecture 100 can equally well find application in, for example, a distributed or peer-to-peer architecture system. The marketplace system 120 and payment system 122 may also be implemented as standalone systems or standalone software programs operating under separate hardware platforms, which do not necessarily have networking capabilities.

Referring now to FIG. 2, an exemplary block diagram illustrating multiple components that, in one exemplary embodiment, are provided within the marketplace system 120 of the networked system 102 (see FIG. 1) is shown. The marketplace system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

The marketplace system 120 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace system 120 may comprise at least one publication engine 202 and one or more auction engines 204 that support auction-format listing and price setting mechanisms (e.g., English, Dutch, Chinese, Double, Reverse auctions, etc.). The various auction engines 204 also provide a number of features in support of these auction-format listings, such as a reserve price feature whereby a seller may specify a reserve price in connection with a listing, and a proxy-bidding feature whereby a bidder may invoke automated proxy bidding.

A pricing engine 206 supports various price listing formats. One such format is a fixed-price listing format (e.g., the traditional classified advertisement-type listing or a catalogue listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the marketplace system 120 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 212. For example, a search module (not shown) of the navigation engine 212 enables keyword searches of listings published via the marketplace system 120. In a further example, a browse module (not shown) of the navigation engine 212 allows users to browse various category, catalogue, or inventory data structures according to which listings may be classified within the marketplace system 120. Various other navigation applications within the navigation engine 212 may be provided to supplement the searching and browsing applications.

In order to make listings available via the networked system 102 as visually informing and attractive as possible, the marketplace system 120 may include an imaging engine 214 that enables users to upload images for inclusion within listings. The imaging engine 214 also operates to incorporate images within viewed listings. The imaging engine 214 may also support one or more promotional features, such as image galleries that are presented to potential buyers. For example, sellers may pay an additional fee to have an image included within a gallery of images for promoted items.

A listing creation engine 216 allows sellers to conveniently author listings pertaining to goods or services that sellers wish to transact via the marketplace system 120, and a listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210.

A messaging engine 222 is responsible for the generation and delivery of messages to users of the networked system 102. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

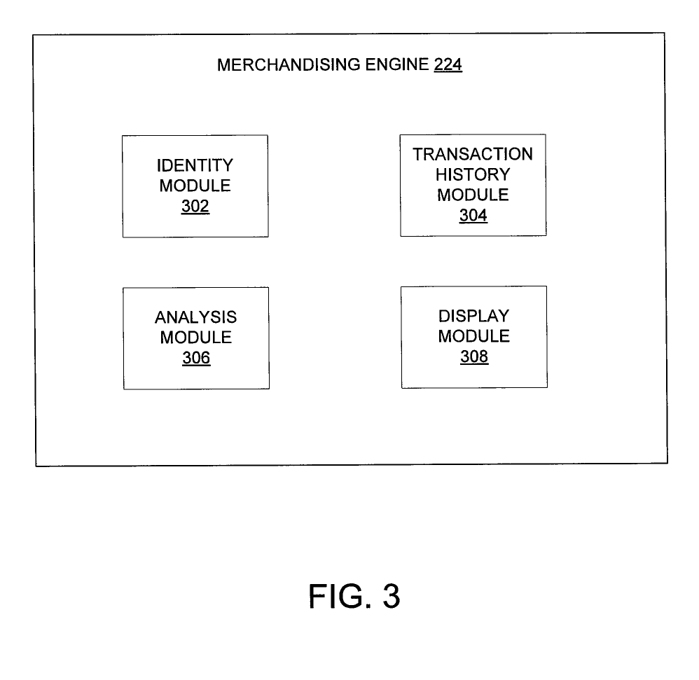

A merchandising engine 224 is provided to enable targeted merchandising to returning buyers. The merchandising engine 224 is discussed in more detail in connection with FIG. 3.

Although the various components of the marketplace system 120 have been defined in terms of a variety of individual modules and engines, a skilled artisan will recognize that many of the items can be combined or organized in other ways. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

Application of Embodiments of the Targeted Merchandising Platform into the Exemplary Network Architecture

Referring now to FIG. 3, an exemplary diagram of the merchandising engine 224 is shown. The merchandising engine 224 provides mechanisms to enable targeted merchandising to returning users. Because these users are more inclined to transact with a familiar merchant (e.g., merchants having a previous relationship of interaction with), providing targeted merchandising from these familiar merchants is beneficial to both the user and the merchant. In exemplary embodiments, the merchandising engine 224 comprises an identity module 302, a transaction history module 304, an analysis module 306, and a display module 308. Alternatively, one or more of the components of the merchandising engine 224 may be located elsewhere in the marketplace system 120. For example, the identity module 302 may be located in an accounts engine which manages user and merchant accounts.

The identity module 302 determines an identity of a returning user. In some embodiments, a cookie may be received from a computing device (e.g., the client machine 110) of the user. A cookie is a small data file created by a web server (e.g., the web server 116) that is stored on a computing device associated with the user either temporarily for a session or permanently on a hard disk (e.g., a persistent cookie). The cookie provides a way for a web site associated with the web server to recognize the user. In other embodiments, the user may have provided login information, such as a user name or password. The login information is then verified by the identity module 302. Thus using the cookie or login information, the identity module 302 can determine an identity of the user.

The transaction history module 304 accesses a transaction history associated with the identified user. In exemplary embodiments, the transaction history comprises a listing of previous transactions involving the identified user. The listings indicate merchants that the user has previously purchased from as well as the item(s) purchased, purchase price, payment information, and any other information related to a purchase transaction. It should be noted that embodiments are not limited to previous purchases, but may include other types of transactions, such as trades or auctions.

In various embodiments, the transaction history module 304 accesses the transaction history for a particular amount of time. For example, only transactions of the last year, quarter, or six months may be accessed. The particular amount of time may be a pre-set or configurable amount of time (e.g., configured by a system administrator or the user).

In various embodiments, the data associated with the previous transactions need to be maintained or associated with the marketplace system 120. In one embodiment, the data may be generated by a batch job which runs at a predetermined time (e.g., once a week or once a month). The data is then stored in a database associated with the marketplace system 120 (e.g., one or more of the information storage databases 126).

Using the transaction history, the analysis module 306 determines one or more related items from familiar merchants related to a previous purchase or transaction to emphasize to the returning user. For example, if the user recently purchased a Canon® EOS 40D camera, the related items may comprise Canon® EOS 40D camera accessories. In other embodiments, the related items are items that are related to a search result. For example, a user may search for an item of interest (e.g., a keyword search for an iPod®). In this example, search results may be returned in a main section of a display (e.g., on a web page) with related items provided tangentially (e.g., iPod® accessories). In yet other embodiments, the related items are items that are upgrades of a previously purchased item. For example, if a new version of the Canon® EOS camera is available (e.g., Canon EOS 50D camera), the new version may be provided as a related item.

In further embodiments, the analysis module 306 may determine items that have a history of being purchased with the previously purchased items (e.g., frequently bought together), or items where customers who bought the previously purchased item also bought (e.g., customer who bought this item also bought). These identified items may be the related items that are emphasized to the returning user.

In exemplary embodiments, each item within a listing (e.g., created by listing creation engine 216) has associated metadata. The metadata identifies the item within various categories and subcategories and provides keywords associated with the item. Thus, the metadata may be used to associate each item with other items that have similar metadata.

It is also noted that exemplary embodiments are not limited to items related to previously purchased items or merchants with whom the user has had a previous purchase transaction. In some embodiments, the user may have indicated a merchant to be a trusted or a favorite seller or merchant. Items from these familiar merchants may also be identified as related items.

The display module 308 then displays (or provides instructions to display) representations of the related items in a prominent manner to the user. In various embodiments, the representations of the related items (e.g., listings, images, or links of the related items) may be displayed, for example, at a top of an item list, be highlighted, have a different colored background, or be outlined. In other embodiments, the representations of the related items may be displayed in a prominent manner along a border of a web page or any other location on a web page where there is available space. In other embodiments, the representations of the related items may be displayed on an initial web page associated with the network-based marketplace. For example, related items may be recommended and displayed on an eBay homepage. Any manner of displaying the representations of the related items in a manner that draws attention to the related items may be utilized.

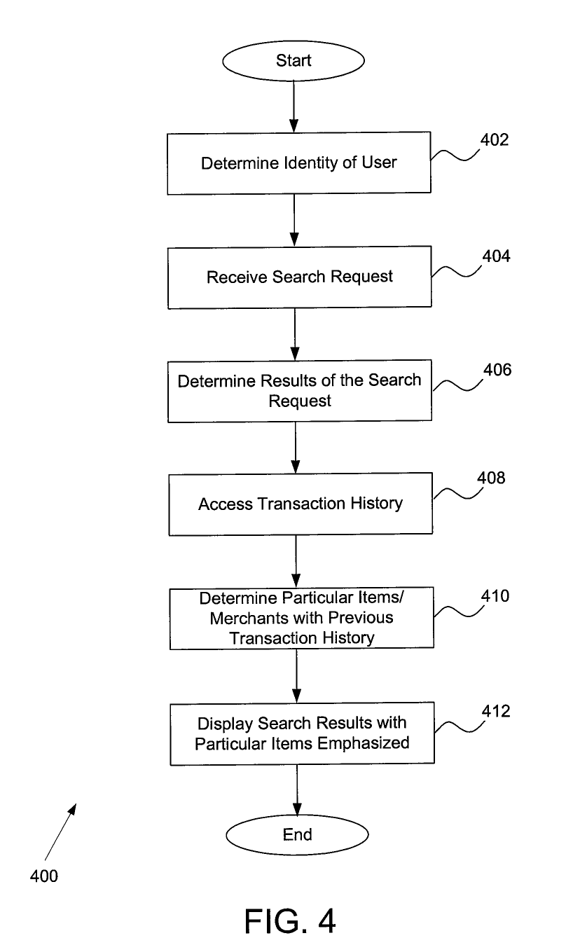

FIG. 4 is a flowchart illustrating an exemplary method 400 for providing targeted merchandising in a search result. The exemplary method 400 occurs when a user submits a search for an item of interest. For example, the user may provide keywords in a search performed by a search module of the navigation engine 212.

At operation 402, an identity of a user is determined. In one embodiment, a cookie may be received from a client machine (e.g., client machine 110) associated with the user. In an alternative embodiment, the user may have logged in with the marketplace system 120 on which the search for the item of interest is performed.

At operation 404, a search request is received from the client machine associated with the user. The search request may comprise a keyword search. Alternatively, the search request may be a selection of a plurality of categories and sub-categories which narrows down onto one or more items of interest. Other forms of searching are also contemplated.

Results of the search request are determined at operation 406. In various embodiments, a search engine of the marketplace system 120 performs a search based on parameters provided in the search request. The search engine may access a database of all published listings for currently available items, review the listings, and find items of interest that match the parameters of the search request.

Substantially simultaneously with the determination of the results, a transaction history of the user is accessed at operation 408. Because the identity of the user has been determined (operation 402), the identity may be used to search a database containing transaction histories. Transactions involving the user based on the identity are determined. In some embodiments, a particular time period of transactions may be reviewed (e.g., last three months). Items purchased and the merchants the items were purchased from are identified. Other familiar merchants may also be identified (e.g., a favorite merchant).

Using the identified previously purchased items and the identified merchants, related items are determined at operation 410. The related items comprise a coordination (e.g., matching) of the search results with the identified familiar merchants. Thus, search results identifying items of interest from a familiar merchant are identified as related items. The coordination may also include a determination of items associated with the search result and the previously purchased items (e.g., accessories or upgraded versions associated with the search result) available from familiar merchants. These associated items may also be identified as related items.

The search results with the related items emphasized are displayed at operation 412. In various embodiments, the representations of the related items may be displayed, for example, at a top of the search results, be highlighted on the search results, have a different colored background, or be outlined. In other embodiments, the representations of the related items may be displayed in a prominent manner along a border of a web page or any other location on a web page displaying the search results. For example, related items having a best match to the search request may be listed as the top three items of the search results.

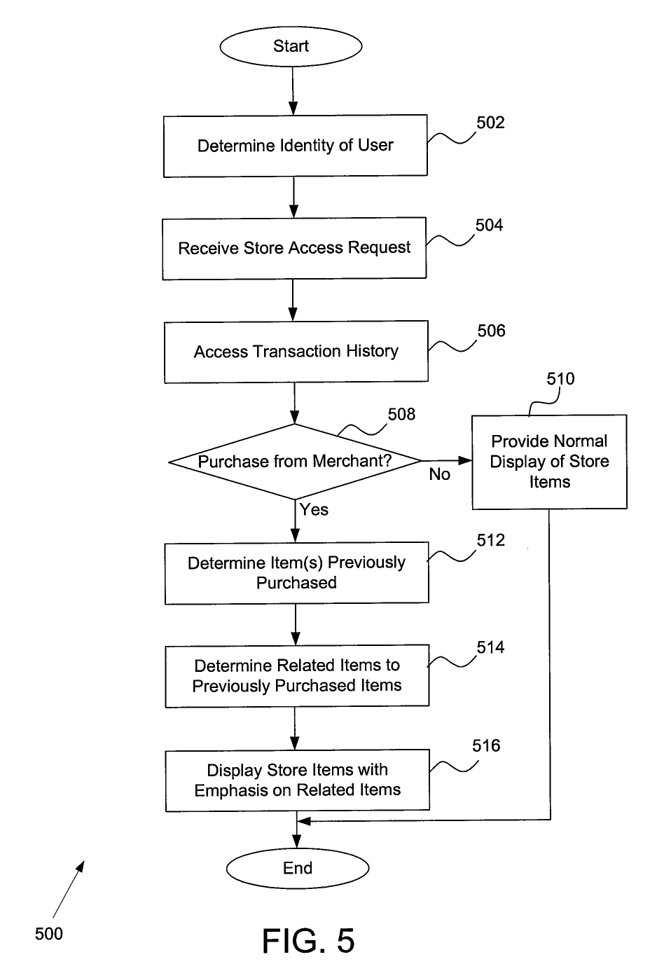

FIG. 5 is a flowchart illustrating an exemplary method 500 for providing targeted merchandising in a virtual store. The exemplary method 500 occurs when a returning user visits a virtual store of a merchant of the electronic marketplace (e.g., generated by the store engine 208). At operation 502, an identity of a user is determined. In one embodiment, a cookie may be received from a client machine associated with the user. In an alternative embodiment, the user may have logged in with the system on which the search of the item of interest is performed.

A store access request is received at operation 504. In exemplary embodiments, the user indicates a desire to access a particular virtual store. For example, the user may select a link that directs a browser associated with the user's client machine (e.g., client machine 110) to a particular virtual store. Alternatively, the user may enter a URL or other identifier to access the virtual store.

A transaction history of the user is accessed at operation 506. Because the identity of the user has been determined (at operation 502), the identity may be used to search a database containing transaction histories. Transactions involving the user based on the identity are determined, and items purchased and the merchants the items were purchased from are identified. A particular time period of transactions may be utilized (e.g., last three months) in determining the previously purchased items and familiar merchants. Other familiar merchants may also be identified (e.g., a favorite merchant).

Based on the transaction history, a determination is made at operation 508 as to whether the user has previously transacted with the merchant associated with the particular virtual store (e.g., determine whether the merchant is a familiar merchant). If the user has not purchased from the merchant or store before, then a normal display of store items is provided at operation 510. In the normal display, items may not be emphasized.

However, if a determination is made at operation 508 that the user has previously purchased from or otherwise interacted with the merchant or store (i.e., the merchant is a familiar merchant), then at operation 512, one or more items previously purchased is determined. In one embodiment, the items previously purchased are items that were purchased from the familiar merchant or store. In other embodiments, the items previously purchased may be any items within a certain time period that the user has purchased, regardless of the merchant or store involved. For example, the user may have purchased an item from Merchant A, but is visiting the virtual store of Merchant B. Thus, items from transactions with both Merchant A and Merchant B may be considered.

At operation 514, related items to the previously purchased items are determined. Determining related items comprises performing coordination or matching of the previously purchased items with items currently being offered in the virtual store. The coordination may include a determination of items associated with the previously purchased items (e.g., accessories or upgraded versions).

An item listing of the virtual store is then displayed with an emphasis on the related items at operation 516. In various embodiments, the representations of the related items may be displayed, for example, at a top of a virtual store listing, be highlighted, have a different colored background, or be outlined. In other embodiments, the representations of the related items may be displayed in a prominent manner along a border of a web page representing the virtual store or any other location on a web page displaying the virtual store.

The familiar merchant may also provide special promotions or coupons to the user who may be a returning buyer. For example, if the user had purchased a particular mobile device from the merchant, the merchant may, via the virtual store, offer a discount to the user for accessories for the particular mobile device.

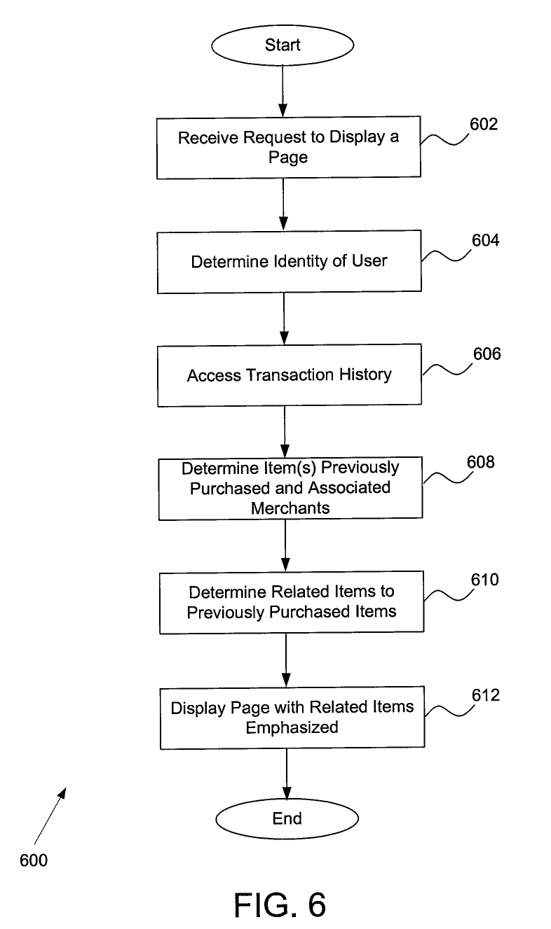

FIG. 6 is a flowchart illustrating an exemplary method 600 for providing targeted merchandising on a requested web page. In exemplary embodiments, the method 600 occurs when a user desires to display a web page (e.g., not associated with a virtual store). For example, the user may access a homepage associated with www.eBay.com.

At operation 602, a request for display of a web page is received. In various embodiments, an application server associated with the marketplace system 120 receives the request.

An identity of a user is determined at operation 604. In one embodiment, a cookie may be received from a client machine associated with the user. In an alternative embodiment, the user may have logged in with the marketplace system 120.

A transaction history of the user is accessed at operation 606. Because the identity of the user has been determined (at operation 602), the identity may be used to search a database containing transaction histories. Transactions involving the user based on the identity are determined. Items purchased and the merchants the items were purchased from are identified from the transactions involving the identified user at operation 608. Other familiar merchants may also be identified (e.g., a favorite merchant). In some embodiments, a particular time period of transactions may be determined (e.g., last 6 months).

At operation 610, related items to the previously purchased items are determined. Determining related items comprises performing coordination or matching of the previously purchased items to items currently being offered in the electronic marketplace that are related (e.g., accessories or upgraded versions). In exemplary embodiments, only related items associated with familiar merchants with whom the user has previously transacted are selected.

At operation 612, the web page is displayed with the related items emphasized. In one embodiment, the web page comprises a recommendation area (i.e., a recommendation section) where representations of the related items may be displayed. In other embodiments, the representations of the related items may be displayed in a region of the web page that is not otherwise utilized (e.g., on a border or an area of the web page that is normally left blank).

It is appreciated that the methods of FIG. 4-FIG. 6 are exemplary. Alternative embodiments may comprise more, less, or functionally equivalent steps. Additionally, the steps of the various methods may be practiced in a different order. For example, a determination of the identity of the user may occur after receiving a search request (at operation 404) and determining results of the search request (at operation 406) or after receiving the store access request (at operation 504).

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

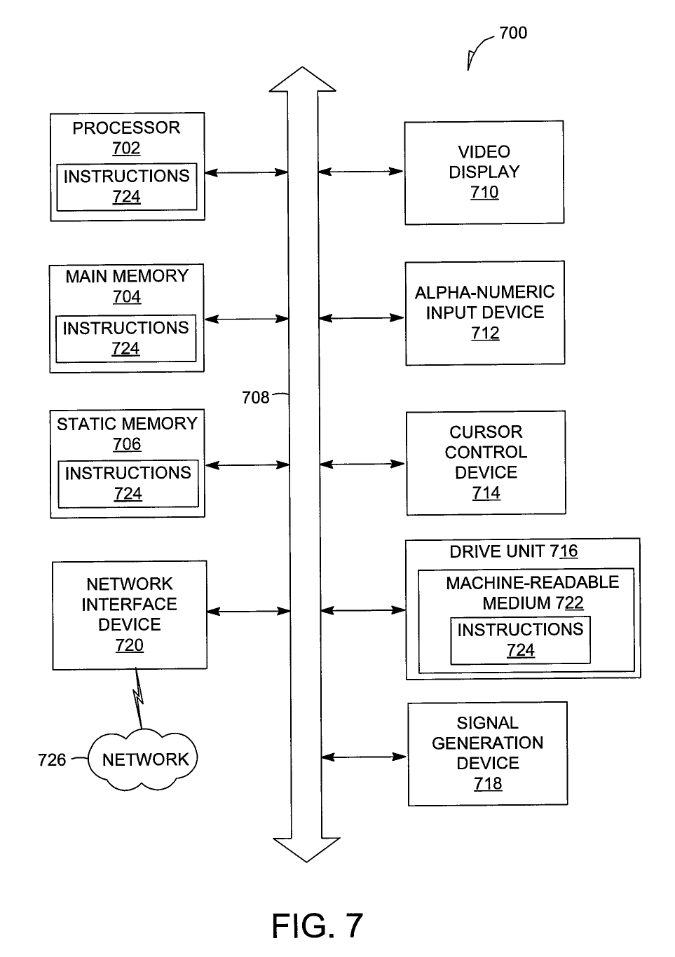

With reference to FIG. 7, an exemplary embodiment extends to a machine in the exemplary form of a computer system 700 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 may include a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). In exemplary embodiments, the computer system 700 also includes one or more of an alpha-numeric input device 712 (e.g., a keyboard), a user interface (UI) navigation device or cursor control device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of instructions 724 and data structures (e.g., software instructions) embodying or used by any one or more of the methodologies or functions described herein. The instructions 724 may also reside, completely or at least partially, within the main memory 704 or within the processor 702 during execution thereof by the computer system 700, the main memory 704 and the processor 702 also constituting machine-readable media.

While the machine-readable medium 722 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method to perform targeted merchandising, comprising:
determining an identity of a user;
accessing a transaction history associated with the identity;
using the transaction history to determine one or more related items from at least one familiar merchant, the at least one familiar merchant having a previous relationship with the user; and
displaying representations of the one or more related items in a prominent manner.

2. The method of claim 1, wherein the one or more related items are accessories of a previously purchased item.

3. The method of claim 1, wherein the one or more related items are upgraded versions of a previously purchased item.

4. The method of claim 1, wherein displaying comprises highlighting the representations of the one or more related items in a different color.

5. The method of claim 1, wherein displaying comprises listing the representations of the one or more related items at a top of a list or display.

6. The method of claim 1, wherein displaying comprises displaying the representations of the one or more related items in a recommendation section.

7. The method of claim 1, further comprising receiving a search request for an item of interest, wherein the representations of the one or more related items are displayed as search results from familiar merchants.

8. A system to perform targeted merchandising, comprising:
an identity module to determine an identity of a user;
a transaction history module to access a transaction history associated with the identity;
an analysis module to determine one or more related items from at least one familiar merchant using the transaction history, the at least one familiar merchant having a previous relationship with the user; and
a display module to display representations of the one or more related items in a prominent manner.

9. The system of claim 8, wherein the display module displays the representations of the one or more related items by highlighting the one or more related items in a different color.

10. The system of claim 8, wherein the display module displays the representations of the one or more related items by listing the one or more related items at a top of a list or display.

11. The system of claim 8, wherein the display module displays the representations of the one or more related items in a recommendation section.

12. A machine-readable storage medium in communication with at least one processor, the machine-readable storage medium storing instructions which, when executed by the at least one processor, provides a method to perform targeted merchandising, the method comprising:
determining an identity of a user;
accessing a transaction history associated with the identity;
using the transaction history to determine one or more related items from at least one familiar merchant, the at least one familiar merchant having a previous relationship with the user; and
displaying representations of the one or more related items in a prominent manner.

13. The machine-readable storage medium of claim 12, wherein the one or more related items are accessories of a previously purchased item.

14. The machine-readable storage medium of claim 12, wherein the one or more related items are upgraded versions of a previously purchased item.

15. The machine-readable storage medium of claim 12, wherein displaying comprises highlighting the representations of the one or more related items in a different color.

16. The machine-readable storage medium of claim 12, wherein displaying comprises listing the representations of the one or more related items at a top of a list or display.

17. The machine-readable storage medium of claim 12, wherein displaying comprises displaying the representations of the one or more related items in a recommendation section.

18. The machine-readable storage medium of claim 12, wherein the method further comprises receiving a search request for an item of interest, wherein the representations of the one or more related items are search results from familiar merchants.

19. A system to perform targeted merchandising, the system comprising:
means for determining an identity of a user;
means for accessing a transaction history associated with the identity;
means for using the transaction history to determine one or more related items from at least one familiar merchant, the at least one familiar merchant having a previous relationship with the user; and
means for displaying representations of the one or more related items in a prominent manner.

20. The system of claim 19 further comprising means for receiving a search request for an item of interest, wherein the representations of the one or more related items are search results from familiar merchants.
